(19) United States
(12) Patent Application Publication
(10) Pub. No.: US 2017/0044024 A1
(43) Pub. Date: Feb. 16, 2017

(54) METHOD FOR TREATING AN AQUEOUS SOLUTION CONTAINING DISSOLVED MATERIALS BY CRYSTALLIZATION OF CLATHRATES HYDRATES

(71) Applicant: BGH, Lacq (FR)

(72) Inventor: Bruno MOTTET, GUIDEL (FR)

(73) Assignee: BGH, Lacq (FR)

(21) Appl. No.: 15/305,783

(22) PCT Filed: Apr. 22, 2015
(86) PCT No.: PCT/EP2015/058722

§ 371 Date: Oct. 21, 2016

(30) Foreign Application Priority Data
Apr. 23, 2014 (EP) 14352001.3

(51) Int. Cl. C02F 1/22; B01D 9/00; C02F 1/26

(52) U.S. Cl. CPC C02F 1/22; C02F 1/265; B01D 9/0004; C02F 2103/08

(57) ABSTRACT

A method is disclosed for treating an aqueous solution containing dissolved materials that are crystallisable by crystallization of clathrates hydrates of a host molecule which crystallize at atmospheric pressure at temperatures higher than the temperature of ice crystallization. This method allows purified water and solid materials or solutions which are highly concentrated in dissolved materials to be produced simultaneously. The disclosure also relates to the implementation of this method.

### TECHNICAL FIELD

The invention relates to a method for treating an aqueous solution containing dissolved materials by crystallization of clathrates hydrates.

More precisely, the invention relates to a method for treating an aqueous solution containing dissolved materials that are able to crystallize (crystallizable), by crystallization of clathrates hydrates of a host molecule which crystallize at atmospheric pressure at temperatures higher than the temperature of ice crystallization.

The method according to the invention allows purified water and solid materials or solutions which are highly concentrated in dissolved materials to be produced simultaneously.

### PRIOR ART

The treatment of solutions rich in dissolved materials is an economic as well as environmental stake.

Very many industries are confronted with this problem whether for recovering dissolved raw materials that can be valorised in the solid state or in the form of highly concentrated solutions, for being able to recycle polluted or contaminated water, for discharging polluted or contaminated water that meets environmental standards, or for producing purified water.

The techniques for carrying out the treatment of these solutions rich in dissolved materials are classed according to the content in dissolved materials of the solutions to be treated and according to the purification yield expected.

Today, two major families of techniques are distinguished for carrying out the treatment of solutions rich in dissolved materials.

The first of these techniques are the techniques intended for treating solutions that have contents in dissolved materials less than 50,000 ppm.

This entails membrane techniques and primarily reverse osmosis.

Reverse osmosis has low operating expense (OPEX) and allows for an enhanced purification of the water, but its yield is low, generally less than 50%.

In addition beyond 50,000 ppm, these physical techniques of purification are confronted with two types of problems, namely the problems of clogging—because the precipitation of the salts clogs the pores of the membranes—and the problems due to the high pressures required for the compensation of the high osmotic pressures of the solutions having a high concentration of dissolved materials.

Beyond 50,000 ppm in dissolved materials, membrane techniques become technically complex and are no longer economically competitive.

The second of these techniques are techniques intended for treating solutions that have high contents in dissolved materials, greater than 40,000 ppm.

These are substantially evaporation techniques.

In these techniques, the solution is heated in order to “extract” the water in the form of steam and as such concentrate the solution. The purified water is recovered by condensation at the end of the method.

These evaporation techniques have a high yield, for example greater than 85% and make it possible to obtain water with high purity.

However, these evaporation techniques come up against three problems.

The first problem is of an economic nature since the vaporisation of the water requires much energy, i.e. about 2,257 kJ/kg, which therefore generates substantial capital expenditure (CAPEX), and high operating expense (OPEX) due to this high consumption of energy.

The second problem is the scaling and the corrosion in relation with the heating system and the high temperature of the treatment.

Finally, the third problem stems from the fact that, according to the nature of the species dissolved, certain compounds (in particular organic or ammonia compounds) can also be vaporised during the treatment at high temperature and as such pollute the water recovered.

In order to overcome the problems that the membrane techniques and the evaporation techniques have, a new technology called “Eutectic Freeze Crystallization” (“EFC” or “Ice EFC”) was developed in the years 2000 by the Delft University of Technology in the Netherlands and is the object of application WO-A1-01/28958.

This technique of EFC implements concomitant crystallizations of ice and of salts at eutectic temperatures. These temperatures are generally negative, for example the temperature of the eutectic is −21° C. for a solution of NaCl (see FIG. 1). The glace is crystallized indirectly by cold surfaces. The ice crystals are recovered mechanically on the cold surfaces, while the salt crystals settle in the reactor. As the pure ice is less dense than the solution, the crystals of ice float on the surface of the solution. The salts are filtered, the ice is collected before it is washed and melted in order to recover purified water.

In relation to membrane techniques and evaporation techniques described hereinabove, this technique of EFC, has the triple advantage of not being limited by the initial concentration in dissolved materials, of having a lesser energy demand in light of the latent heat of the crystallization of the ice which is 333 kJ/kg, and of avoiding all of the problems linked to the implementation of high temperatures.

This technique however has two inconveniences that substantially handicap its industrial development.

The first inconvenience is linked to the technique of crystallising ice.

The cold is indeed transmitted by cold surfaces that constitute the cold point of the system and which are the privileged location for the crystallization of the ice crystals.

In order to then be pulled off from the cold surfaces, and float on the surface in the solution, these ice crystals have to be collected mechanically by scraping the cold surfaces.

Scraping devices undergo substantial mechanical wear and tear, which causes high maintenance costs in order to maintain them in operation and prevent any caking which would be catastrophic.

Finally, the crystalline growth of ice is difficult to control. As all of the water of the system is subjected to the thermodynamic conditions of crystallization, the crystals develop morphologies referred to as “dendritic”, due to anisotropic growth. Such crystals are able to trap many inclusions of liquids, or serve as a support for nucleation for salts as is exposed in the document of Willem van der Tempel, Master Thesis Delft University of Technology, “Eutectic Freeze Crystallization: Separation of Salt and Ice”, June 2012. This results in substantial problems in the separation and floating of “impure” ice crystals which then have a density, greater than the density of the pure ice, which does not allow them to float on the surface of the solution. Finally, the melting of the “impure” ice crystals gives water that is still loaded in dissolved material.

There is therefore a need for a method that, while having the advantages of the method of “Eutectic Freeze Crystallization” does not have the inconveniences due in particular to the crystallization of the ice and to the recovering of it.

Moreover, clathrates hydrates are known which are crystalline compounds constituted by a cage formed of molecules of water trapping in their core a molecule referred to as “host molecule” that stabilised the edifice.

There are very many host molecules that make it possible to crystallize clathrates hydrates. Mention can be made among others of: N₂, CO₂, Ar, H₂S, Kr, Xe, CH₃CCl₂F, CH₃CClF₂, CH₃CHF₂, CHClF₂, C₃H₆, CH₂CClF, CH₃Cl, methane, ethane, butane, propane, cyclopentane, and certain quaternary ammonium salts.

When the host molecule is a molecule in gaseous state, these clathrates hydrates are commonly called “Gas Hydrates”.

The pressure and temperature conditions in which these various clathrates hydrates in solution will form depend on the nature of the host molecule and of the species dissolved in the solution.

The number of water molecules associated with each host molecule also depends on the nature of the host molecules.

In a saline solution saline and at adapted temperatures, the crystallization of the clathrates hydrates is subject to the same eutectic phenomenon as ice.

However, the temperature of the eutectic of a saline solution, for example of a saline solution of NaCl, containing a clathrate hydrate of a host molecule is higher than the temperature of the eutectic of this same solution that does not contain clathrates hydrates, as in the same way, the crystallization temperature of a given clathrate hydrate is lower than the temperature of ice crystallization (see FIG. 1 and FIG. 2).

The two documents studied hereinbelow disclose methods for treating saline solutions using clathrates hydrates.

The document WO-A1-2005/000746 (U.S. Pat. No. 7,794,603 B2) describes a method for the purification of a contaminated water, by the formation of hydrates and separation of the hydrates from the contaminated water enriched in contaminants wherein particles of hydrate are added to the water while the hydrates are forming.

The contaminated water can be in particular an aqueous phase coming from oil exploration, and the contaminants can be in particular hydrocarbons, or salts such as NaCl.

The separated contaminants are then treated, for example by recycling them or by discharging them.

More precisely, this method comprises the steps of adding a compound forming hydrates (host molecule), and hydrate seeds to the water, the forming of hydrates in adequate temperature and pressure conditions, the recovering of the hydrates from the contaminated water, and the dissociating of the hydrates into pure water and into host molecule.

The host molecules can be chosen from lower hydrocarbons, CO₂, halogenated hydrocarbons, tetrahydrofuran, ethylene oxide, noble gases, sulphur hexafluoride, N₂O. Preferably, the host molecules are chosen from C1 to C5 hydrocarbons—this is therefore linear or branched and non-cyclic hydrocarbons—or CO₂, more preferably from methane, ethane, propane, and CO₂. The most preferred host molecules of all are methane or CO₂. It should be noted that cyclopentane is not mentioned.

According to claim 10, the pressure used is greater than atmospheric pressure. In tables 2, 3, and 4, the host molecules are gaseous molecules namely CO₂, methane or ethane and the pressures implemented which are required in order for a hydrate to form are very clearly greater than atmospheric pressure.

The method of this document therefore substantially implements gaseous host molecules that have the inconvenience of requiring high pressures.

The method of this document substantially has for purpose to purify the water and takes no interest whatsoever in valorising concentrates. There is no mention in this document of a recovering of the dissolved materials in the form of a solid or of any modulation of the concentration of concentrates according to the different channels for valorisation.

In other words, the only product provided by this method is pure water.

The method of this document cannot treat contaminated water of which the content in contaminants, such as salts, exceed 25% by weight. Indeed, this method substantially implements gas hydrates, such as CO₂, which are denser than water, and therefore the hydrates cannot be separated from the contaminants such as salts.

The document U.S. Pat. No. 8,454,926 B2 describes a method and a system for separating a solute using an aqueous solution wherein:
a first aqueous solution saturated with a solute which is a salt such as sodium chloride, is put into contact with a clathrates forming agent (host molecule) under conditions that allow for the formation of clathrates and the precipitation of the solute from the first aqueous solution;
the precipitated solute is separated from the clathrates by withdrawing a first stream comprising the clathrates and the solute, and by withdrawing a second stream comprising the precipitated solute;
the clathrates are decomposed into the host molecule and into a second aqueous solution comprising the solute at a concentration lower than the concentration of the solute in the first aqueous solution; and
the second aqueous solution is recycled by putting into contact the second aqueous solution with a source of solute in order to form a third aqueous solution which is used as a first aqueous solution or in combination with the latter.

The host molecules are in particular gases with a low molecular mass such as oxygen, nitrogen, CO₂, H₂S, argon, krypton and Xenon or halogenated hydrocarbons, or gaseous hydrocarbons such as methane, propane, ethane and butane. Cyclic hydrocarbons such as cyclopentane are not mentioned.

The gaseous host molecules have the major inconvenience of requiring high pressures.

The purpose of the method of this document is substantially to produce, to crystallize, salt with a high purity from brines from salt mines.

There is no mention in this document that pure water is also recovered.

In other words, the only product provided by this method is salt.

There is therefore with regards to the above a need for a method for treating an aqueous solution containing dissolved materials that are crystallisable, by crystallization of clathrates hydrates, that does not have the inconveniences, defects and disadvantages of the methods of treating saline solutions using clathrates hydrates described in documents WO-A1-2005/000746 (U.S. Pat. No. 7,794,603 B2) and U.S. Pat. No. 8,454,926 B2 and which overcomes the problems of the methods of these documents.

The purpose of this invention is to meet among other things, this need.

### DISCLOSURE OF THE INVENTION

This purpose, and also others, are achieved, in accordance with the invention by a method for treating an aqueous solution containing dissolved materials that are able to crystallize or precipitate (i.e. crystallisable or precipitable) by crystallization of clathrates hydrates of a host molecule which crystallize at atmospheric pressure at temperatures higher than the temperature of ice (solid water) crystallization, said clathrates hydrates being less dense than said aqueous solution containing dissolved materials, wherein the following steps are carried out:
a) the aqueous solution is cooled to a temperature T1 that is higher than the temperature of ice crystallization and lower than the crystallization temperature Teq of the clathrates hydrates, and this cooled aqueous solution is introduced into a thermally insulated reactor;
b) a quantity of the host molecule is added into the reactor containing the cooled aqueous solution, such that the temperature T2 of the aqueous solution remains, following this addition and following the exothermic release due to the crystallization of the clathrates hydrates, lower than the temperature Teq, whereby the clathrates hydrates of the host molecule crystallize homogeneously in all of the volume of the aqueous solution by forming a suspension of crystallized clathrates hydrates in an aqueous solution concentrated in dissolved materials that may further contain crystallized or precipitated dissolved materials (for example if one is at the eutectic);
c) the suspension formed during step b) is sampled in the reactor, and said suspension is sent to a decanter wherein it is separated into an aqueous solution concentrated in dissolved materials and free of clathrates hydrates, into a suspension of clathrates hydrates crystallized in the form of a sorbet (crystallized hydrate in a concentrated solution) in an aqueous solution concentrated in dissolved materials and free of crystallized or precipitated dissolved materials, and optionally, possibly, into a supersaturated suspension containing crystallized or precipitated dissolved materials and free of clathrates hydrates in an aqueous solution concentrated in dissolved materials;
d) from the decanter is withdrawn on the one hand the aqueous solution concentrated in dissolved materials and free of clathrates hydrates, and optionally on the other hand (for example if one is in eutectic conditions), the supersaturated suspension containing crystallized or precipitated dissolved materials and free of clathrates hydrates;
e) the aqueous solution concentrated in dissolved materials and free of clathrates hydrates withdrawn in step d), is sent back in whole into the reactor after having possibly been cooled; or else, if in the decanter there is no supersaturated suspension then a portion of the aqueous solution concentrated in dissolved materials and free of clathrates hydrates withdrawn in step d), is sent back into the reactor after having possibly been cooled, and another portion of the aqueous solution concentrated in dissolved materials and free of clathrates hydrates withdrawn in step d), is recovered and/or discharged through a purge;
f) the suspension of clathrates hydrates crystallized in the form of a sorbet in an aqueous solution concentrated in dissolved materials and free of crystallized or precipitated dissolved materials obtained in step c), is sent into a liquid/solid separation apparatus, such as a filter, wherein solid clathrates hydrates are separated from the aqueous solution concentrated in dissolved materials and free of crystallized or precipitated dissolved materials (filtrate) which is recycled in order to form at least a portion of the aqueous solution cooled in step a);
g) the solid clathrates hydrates separated in the step f) are sent into a reactor for dissociating clathrates hydrates in which the clathrates hydrates are dissociated into purified water and into host molecules;
h) the purified water and the host molecules obtained in the step g) are separated, the purified water is recovered, and the host molecules are recycled in the step b).

The method according to the invention has a specific combination of specific steps which has never been described or suggested in prior art such as represented in particular by the documents studied hereinabove.

The method according to the invention makes it possible to obtain on the one hand a purified water and on the other hand dissolved materials in a form that can be valorised, either in the form of a highly concentrated solution or in the form of a solid, making use of the crystallization of water molecules in the form of clathrates hydrates, and not of ice.

In the methods of prior art exposed hereinabove that implement clathrates hydrates, either only pure water, or only salt, are obtained. On the contrary, the method according to the invention makes it possible for the first time, by using clathrates hydrates, to obtain both, simultaneously, water of high purity and dissolved materials that can potentially be reused. According to another advantage of the method according to the invention, the concentration and/or the form—liquid or solid—of the dissolved materials recovered that can potentially be valorised can be easily modulated.

In other terms, the method according to the invention acts both as a purifier of water and as a concentrator of dissolved materials.

In particular, the method according to the invention is fundamentally distinguished from the methods of prior art in particular by the steps a) and b), as well as c), d), and e).

In the method according to the invention, the cooling phase (step a)) is separated, dissociated, distinct from the crystallization phase of the water molecules (step b)) and the water molecules crystallize in the form of clathrate hydrate, and not of ice as for example in the method of document WO-A1-01/28958.

This crystallization is produced during the adding of the host molecule to the cooled aqueous solution. This crystallization is produced internally, directly and homogeneously, in all of the volume of the aqueous solution contained in the reactor, uniformly cooled beforehand, and not simply in limited volumes of this solution, progressively cooled indirectly by cold surfaces.

The recovering of the crystals of clathrates is therefore much easier as all of the problems linked to the mechanical scraping of surfaces are avoided.

According to the invention, the phase of crystallization of the water in the form of clathrates hydrates at the core of the aqueous solution, in all of the volume of the aqueous solution, makes it possible to prevent the problems of dendritic growth and of the trapping of inclusions of dissolved materials for example of saline inclusions in the crystals of clathrates hydrates. A purified water of high quality can thus be produced.

The method according to the invention is also distinguished from the methods of prior art and in particular from the method of document WO-A1-2005/000746 (U.S. Pat. No. 7,794,603 B2) by the implementing of step c), then of step d) during which the suspension formed during step b) is sampled in the reactor, said suspension is sent to a decanter wherein it is separated into an aqueous solution concentrated in dissolved materials and free of clathrates hydrates, into a suspension of clathrates hydrates crystallized in the form of sorbet (crystallized hydrate in concentrated solution) in a solution concentrated in dissolved materials and free of crystallized or precipitated dissolved materials, and possibly, optionally into a supersaturated suspension containing crystallized or precipitated dissolved materials and free of clathrates hydrates; and then the aqueous solution concentrated in dissolved materials and free of clathrates hydrates is withdrawn from the decanter, and optionally, possibly, the supersaturated suspension containing crystallized or precipitated dissolved materials and free of clathrates hydrates.

The method according to the invention is distinguished, furthermore, from the methods of prior art and in particular from the method of document WO-A1-2005/000746 by the implementing of a step e) following step c) and step d), during which the aqueous solution concentrated in dissolved materials and free of clathrates hydrates withdrawn in step d), is sent into the reactor.

The step e) makes it possible to reach the eutectic or to maintain the supersaturation in the crystallization loop (i.e. the circuit comprising the reactor, the decanter and optionally a heat exchanger wherein circulates between the reactor and the decanter the suspension formed in step b) then between the decanter and the reactor the aqueous solution concentrated in dissolved materials and free of clathrates hydrates withdrawn in step d)) in order to crystallize or precipitate the salts in the decanter, and in order thus to obtain (when eutectic is reached) the supersaturated suspension containing crystallized or precipitated dissolved materials and free of clathrates hydrates.

It should be noted that, during step b), the crystallization is carried out in a dynamic medium, agitated in the reactor, and that there is generally no separation of the crystallized, precipitated dissolved materials during this step.

However, it is not entirely excluded that such a separation, decantation of the crystallized, precipitated dissolved materials, such as salts, occurs in the reactor, in which case these settled crystallized, precipitated dissolved materials may be withdrawn from the reactor through a purge, provided for in the reactor, generally in its bottom portion.

This phenomenon of separation, decantation of the crystallized, precipitated dissolved materials in the reactor is in particular linked to parameters such as the dimension of the reactor.

On the other hand, the separation is done generally in the decanter in a non agitated medium, or in any case less agitated than in the reactor.

In the method according to the invention, it is furthermore possible to make use of the advantageous thermodynamic conditions of the crystallization of certain clathrates hydrates such as clathrates hydrates wherein the host molecule is cyclopentane in order to decrease the energy demand (less Cold) in relation to methods that call upon the crystallization of ice.

In other terms, the advantages of the method according to the invention can be listed as such:
simultaneous production of dissolved materials such as salts and of pure water and therefore no discharge, the method according to the invention can be qualified as “zero discharge method”;
recycling and valorisation of the solid dissolved materials such as salts, or concentrates;
high yield, for example greater than 95%;
high concentrations of solutions that cannot be directly treated with membrane techniques (RO);
method operating at atmospheric pressure and at reasonable temperatures, for example from −20° C. to 7° C.;
method that consumes much less energy that the evaporation methods.

Indeed, the enthalpy of the vaporisation of water, which is 2257 kJ/kg is much higher than the enthalpy of the crystallization of clathrates hydrates which is only 284 kJ/kg for cyclopentane clathrate hydrate;
stable method, in particular when it operates at eutectic temperature and concentration;
method consuming less energy than the “Ice EFC” method of document WO-A1-01/28958, as the temperatures of the eutectics with the solutions of clathrates hydrates are higher and that it is therefore necessary to supply less Cold;
method that is technically more reliable than the “Ice EFC” method as the crystallization of water is internal and direct during the supply of the host molecule, such as cyclopentane, and that there is no scraped surface.

Advantageously, the method according to the invention is carried out continuously.

The dissolved materials that are crystallisable, precipitable can be chosen from mineral salts such as NaCl, organic salts, and water soluble compounds that have a eutectic crystallization in aqueous solution, and preferably having a density (specific gravity) that is greater than that of the treated aqueous solution containing dissolved materials, for example a density greater than 1.2. The method according to the invention makes it possible to treat a large variety of solutions containing dissolved materials.

As such, advantageously, the aqueous solution containing dissolved materials can be chosen from seawater; brackish waters; public landfills leachates; waters from oil production; waters for extracting shale gas by the hydraulic fracturing technique; liquids from the agri-food industry such as fruit juices or coffee; liquids from the pharmaceutical industry; liquids from the chemical industry; mining effluents, for example mining discharges loaded with sulphates, phosphates or carbonates; effluents from the metallurgy industry; effluents from the nuclear industry; reverse osmosis concentrates; scaling solutions; effluents from the paper industry; saline aquifers.

The method according to the invention makes it possible to treat aqueous solutions with a wide range of concentrations, and in particular aqueous solutions with high contents of dissolved materials that cannot be treated by membrane techniques.

As such, advantageously, the aqueous solution treated (contained in the reactor) has a concentration of dissolved materials from 5 g/L to the limit of saturation of these dissolved materials in water, more preferably from 20 g/L to the limit of saturation of these dissolved materials in water.

According to the invention, a host molecule that makes it possible to crystallize clathrates hydrates at atmospheric pressure at temperatures higher than that of the crystallization of ice is added to the cooled aqueous solution contained in the reactor in order to crystallize the clathrate hydrate.

Advantageously, the host molecule is non-miscible in water.

Advantageously, the host molecule is chosen from the molecules that form a clathrate hydrate that has a density lower than 1.3, preferably lower than 1.2.

Indeed, the solutions concentrated in dissolved materials can have densities ranging generally from 1.2 to 1.3.

Preferably, the host molecule is cyclopentane or cyclohexane.

Indeed, cyclopentane clathrate hydrate associates 17 water molecules per molecule of cyclopentane in the structure [C₅H₁₀].17H₂O.

Cyclopentane makes it possible to crystallize clathrates hydrates under atmospheric pressure at temperatures higher than the temperature of ice crystallization, since cyclopentane clathrate hydrate has a crystallization temperature (or equilibrium temperature) of about 7° C. in the presence of pure water.

Cyclopentane is in liquid state under normal conditions. It is non-miscible in water and makes it possible to crystallize clathrates hydrates with a density less than that of water, as cyclopentane clathrate hydrate has a density of 0.95.

The addition of the host molecule into the cooled solution contained in the reactor can be carried out via any technology, that allows for a good dispersion of this host molecule in the solution in such a way as to favour a homogenous crystallization of the clathrate hydrate in all of the volume of the solution contained in the reactor.

Advantageously, during step b), the host molecule is introduced into the reactor in the form of an emulsion or solution prepared by mixing the aqueous solution cooled to the temperature T1 and the host molecules separated in step h).

Advantageously, during step c), since clathrate hydrate is less dense than the aqueous solution contained in the decanter, advantage is taken from this low density of the crystals of clathrates hydrates, and, the suspension of clathrates hydrates crystallized in the form of a sorbet (crystallized hydrate in a concentrated solution) in an aqueous solution concentrated in dissolved materials and free of crystallized or precipitated dissolved materials is separated, preferably continuously, on the surface of the concentrated aqueous solution.

During step g) carried out in a dissociation reactor, the clathrates hydrates are dissociated into purified water and into host molecules.

Generally, this dissociation of the crystals of hydrate crystallized in a concentrated medium is carried out via an increase in the temperature which leads to the melting thereof.

In other words, the crystals of hydrate crystallized in a concentrated medium are melted.

Advantageously, during step h), the purified water and the host molecules are separated by decantation or degassing.

Choosing one or the other of the decantation or degassing techniques is done according to the more or less volatile nature of the host molecule.

In the case of cyclopentane, preference is given to recovering it by decantation.

Advantageously, solid clathrates hydrates separated in step f) may be washed prior to step g).

Indeed, according to the desired level of purity for the water produced by the method, a step of washing of the clathrates hydrates may be carried out upstream of the step of dissociation, for example of melting g), for example during step f).

This washing may be carried out by a any solution with a content in dissolved material lower than the liquid phase of the sorbet.

According to the desired level of purity, the washing solution may be a portion of the dissociation, melting water, obtained in a preceding cycle of the method, a given quantity of the initial solution to be treated in a following cycle, or a mixture of both.

After the step of dissociation, melting g), the fraction of the host molecule recovered in step h), may be reintroduced upstream of the following, next, crystallization cycle.

Advantageously, the temperature of the aqueous solution in the reactor and/or the concentration in host molecules in the reactor and/or the decanter, and/or the quantity of aqueous solution concentrated in dissolved materials and free of clathrates hydrates withdrawn in step d), and sent back into the reactor during step e) may be adjusted in order to obtain in the decanter during step c), in addition to a suspension of clathrates hydrates crystallized in the form of a sorbet, either only an aqueous solution concentrated in dissolved materials having a determined concentration, or an aqueous solution concentrated in dissolved materials having a determined concentration and a supersaturated suspension containing crystallized or precipitated dissolved materials in an aqueous solution concentrated in dissolved materials (one is then at the eutectic).

Preferably, the temperature of the aqueous solution in the reactor, and/or the concentration in host molecules in the reactor and/or the decanter, and/or the quantity of aqueous solution concentrated in dissolved materials and free of clathrates hydrates withdrawn in step d), and sent back into the reactor during step e), may be adjusted in such a way that eutectic conditions are present in the reactor and/or in the decanter, and that is then obtained in the decanter during step c), in addition to a suspension of clathrates hydrates crystallized in the form of a sorbet, an aqueous solution concentrated in dissolved materials at eutectic concentration and a supersaturated suspension containing crystallized or precipitated dissolved materials in an aqueous solution concentrated in dissolved materials at the eutectic concentration.

This supersaturated suspension containing crystallized or precipitated dissolved materials in an aqueous solution for example at eutectic concentration is withdrawn in step d), and may be treated in a step of solid-liquid separation for example a filtration step, whereby on the one hand crystallized or precipitated dissolved materials are obtained, which are recovered, and on the other hand an aqueous solution concentrated in dissolved materials is obtained, for example at the eutectic concentration, which is recycled in the reactor after having possibly been cooled, and/or is recovered, and/or is fully or partially discharged, for example through a purge.

Indeed, according to their composition, destination, the dissolved materials may be recovered and reused in different forms.

The form of recovery that is a priori the simplest is to recover them in the form of a highly concentrated liquid solution.

The obtaining of such a solution is obtained by adapting the quantity of crystallized clathrate hydrate. The higher the quantity of clathrate hydrate crystallized is, the more concentrated the solution will be. The two parameters that make it possible to control this concentration will therefore indirectly be the temperature of the medium and the quantity of the host molecule:
the more the solution will concentrate, the more it will be necessary to lower the temperature in order to remain within the thermodynamic domain of the crystallization of clathrate hydrate;
in order to continue crystallising the clathrate hydrate as the crystallization solution becomes concentrated and is cooled, the reaction medium needs to be supplied with a host molecule;
the liquid concentrate may be extracted through a purge at the bottom of the decanter.

If the thermodynamic conditions for the crystallization of the clathrate hydrate are maintained, the level of concentration of this concentrate will be all the more so higher as the relative flow rate of this purge in relation to the input flow rate of the solution to be treated is low.

The second form for valorising all or a portion of the dissolved materials is in solid form. The various dissolved materials, in particular salts, can indeed crystallize or precipitate if the eutectic conditions (temperature and concentration) that are specific to them are reached. By adapting the temperature of the method and by crystallising a sufficient quantity of clathrate, the dissolved materials will crystallize or precipitate at the core of the solution by supersaturation compared to eutectic concentration. The dissolved materials, such as salts, crystallized or precipitated, having densities generally much higher than that of the solution, these dissolved materials such as salts will tend to settle in the decanter and concentrate at the bottom of the decanter. Simultaneously, the hydrates, which generally have a density lower than the solution float on the surface of the latter.

In other words, a densimetric separation is carried out of the dissolved materials, such as salts, and hydrates. For example, the density of the solution may be about 1.2 for a supersaturated solution of NaCl, the density of the cyclopentane hydrates may be about 0.95 and the hydrates float, and the density of the NaCl salts may be about 2 and the salt crystals or precipitates sink.

Once settled, the dissolved materials such as the salts may be collected at the bottom of the decanter in the form of a supersaturated solution containing solid crystallized or precipitated dissolved materials in an aqueous solution at eutectic concentration. The solid crystallized or precipitated dissolved materials may then be separated from the aqueous solution at eutectic concentration concentrated by any adapted liquid/solid separation technology.

The liquid phase at eutectic concentration may be potentially recycled in the reactor, and/or discharged, and/or entirely or partially recovered for example via a liquid purge of concentrate.

Finally, advantageously, seeds of solid dissolved materials may be further introduced into the decanter, in particular when the aqueous solution concentrated in dissolved materials reaches eutectic concentration for the first time.

In other words according to the dissolved materials, such as salts, it may be advantageous to seed the solution in order to favour the crystallization or precipitation thereof or the decantation thereof.

The invention furthermore relates to an installation for the implementation of the method such as described hereinabove, in order to treat an aqueous solution containing dissolved materials that are able to crystallize or precipitate (crystallisable or precipitable) by crystallization of clathrates hydrates of a host molecule which crystallize at atmospheric pressure at temperatures higher than the temperature of ice crystallization, said clathrates hydrates being less dense than said aqueous solution containing dissolved materials, said installation comprising:
a) first cooling means, such as a heat exchanger, in order to cool the aqueous solution to a temperature T1 higher than the temperature of ice crystallization and lower than the crystallization temperature Teq of the clathrates hydrates;
b) a thermally insulated reactor;
c) means, such as a pipe, for conveying the aqueous solution cooled to the temperature T1 from the first cooling means to the thermally insulated reactor;
d) means for adding a host molecule in the reactor, whereby the clathrates hydrates of the host molecule crystallize homogeneously in all of the volume of the aqueous solution by forming a suspension of clathrates hydrates crystallized in an aqueous solution concentrated in dissolved materials that may further optionally contain crystallized or precipitated dissolved materials;
e) a decanter;
f) means for sampling in the reactor a suspension of clathrates hydrates crystallized in an aqueous solution concentrated in dissolved materials that may further contain crystallized or precipitated dissolved materials and means, such as a pipe, in order to send said suspension in the decanter wherein said suspension is separated into an aqueous solution concentrated in dissolved materials and free of clathrates hydrates, into a suspension of clathrates hydrates crystallized in the form of a sorbet in an aqueous solution concentrated in dissolved materials and free of crystallized or precipitated dissolved materials, and possibly, optionally, into a supersaturated suspension containing crystallized or precipitated dissolved materials and free of clathrates hydrates in an aqueous solution concentrated in dissolved materials;
g) means for withdrawing from the decanter the aqueous solution concentrated in dissolved materials and free of clathrates hydrates, and possibly, optionally, the supersaturated suspension containing crystallized or precipitated dissolved materials and free of clathrates hydrates;
h) means, such as a pipe, for sending back in whole or in part into the reactor the aqueous solution concentrated in dissolved materials and free of clathrates hydrates withdrawn in the decanter;
i) possibly, optionally, second cooling means, such as a heat exchanger, for cooling before the reactor the aqueous solution concentrated in dissolved materials and free of clathrates hydrates withdrawn in the decanter provided in the means, such as a pipe, for sending back in whole or in part into the reactor the aqueous solution concentrated in dissolved materials and free of clathrates hydrates withdrawn in the decanter;
j) possibly, optionally, purging means provided in the decanter for recovering and/or discharging another portion of the aqueous solution concentrated in dissolved materials and free of clathrates hydrates withdrawn in the decanter;
k) first liquid/solid separation means such as a filter;
l) means, such as a pipe for sending the suspension of clathrates hydrates crystallized in the form of a sorbet in an aqueous solution concentrated in dissolved materials and free of crystallized or precipitated dissolved materials separated in the decanter in the first liquid/solid separation means such as a filter where solid clathrates hydrates are separated from the aqueous solution concentrated in dissolved materials and free of crystallized or precipitated dissolved materials forming a filtrate;
m) means such as a pipe for recycling said filtrate in said first cooling means;
n) a reactor for dissociating solid clathrates hydrates separated in said first liquid/solid separation means, in which the solid clathrates hydrates are dissociated into purified water and into host molecules;
o) means for separating the purified water and the host molecules obtained in the dissociation reactor, means for recovering the purified water, and means, such as a pipe, for sending the host molecules back into the reactor.

Advantageously, the installation may comprise means, such as an emulsifier, in order to prepare an emulsion or solution by mixing the aqueous solution cooled to the temperature T1 in the first cooling means and the host molecules, and means for introducing said emulsion or solution into the reactor.

Advantageously, the installation may further comprise means, for washing the solid clathrates hydrates separated in the first liquid/solid separation means.

Advantageously, the installation may further comprise second solid/liquid separation means, such as a filter, for treating the supersaturated suspension containing crystallized or precipitated dissolved materials in an aqueous solution withdrawn in the decanter and obtaining on the one hand crystallized or precipitated dissolved materials, and on the other hand an aqueous solution concentrated in dissolved materials.

Advantageously, the installation may further comprise, means for recycling in the reactor the aqueous solution concentrated in dissolved materials obtained in the second solid/liquid separation means.

Advantageously, the installation may further comprise, third cooling means, preferably combined with the second cooling means, such as a heat exchanger, for cooling before the reactor the aqueous solution concentrated in dissolved materials.

Advantageously, the installation may further comprise means for introducing seeds of solid dissolved materials into the decanter.

The invention will be better understood when reading the following detailed description, provided for the information and non-limiting purposes.

This detailed description of the invention relates in particular to particular embodiments and is made in relation with the attached drawings.

### BRIEF DESCRIPTION OF THE DRAWINGS

FIG. 1 is a phase diagram for an aqueous solution of a salt such as NaCl.

This diagram shows that the formation temperature of pure ice is 0° C. and that the eutectic point for a solution of NaCl is located at a temperature of −21° C. and at a concentration in NaCl of 23% by weight.

On the abscissa is plotted the concentration in salt (as a % by weight) and on the ordinates is plotted the temperature of the solution (in ° C.).

FIG. 2 is a phase diagram for an aqueous solution of a salt such as NaCl containing host molecules, in particular gaseous host molecules that form clathrates hydrates.

This diagram shows that the freezing temperature of the clathrates hydrates is 7° C., and that the eutectic point for a solution of NaCl is located at a temperature higher than −21° C., namely 13° C.

On the abscissa is plotted the concentration in salt (as a % by weight) and on the ordinates is plotted the temperature of the solution (in ° C.).

FIG. 3 is a flow-sheet of a preferred embodiment of the method according to the invention, implemented continuously.

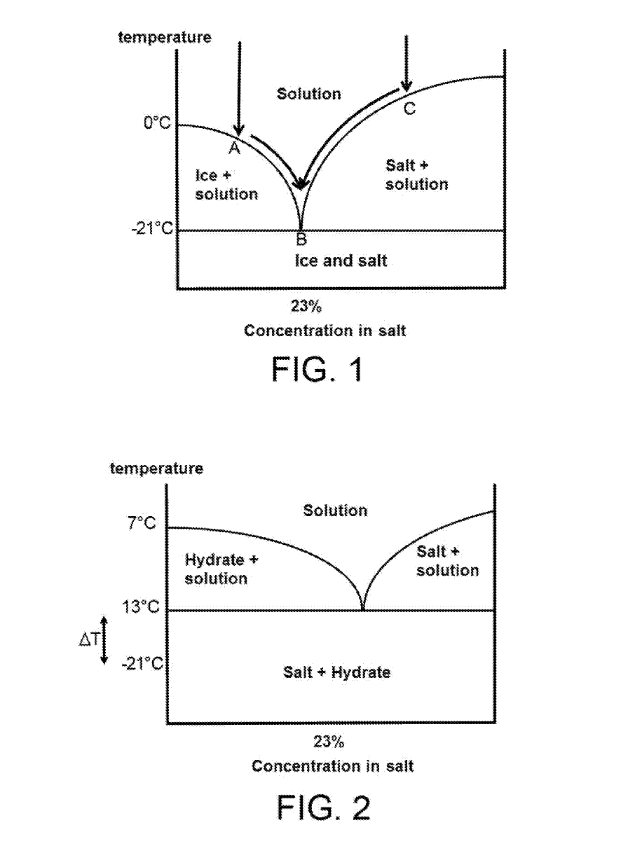

### DETAILED DESCRIPTION OF PARTICULAR EMBODIMENTS

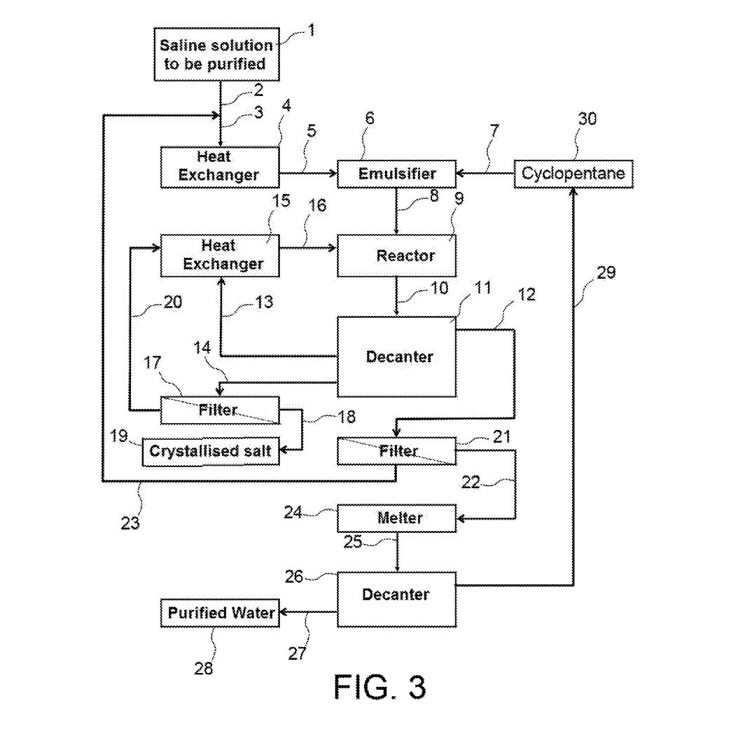

FIG. 3 shows a preferred embodiment of the method according to the invention, implemented continuously, in order to purify for example a saline solution of NaCl, for example at 35 g/l, which is a content similar to that of seawater.

It is obvious that this saline solution is provided solely as an example and that the method shown in FIG. 3 can be used to purify any aqueous solution containing dissolved materials that are able to crystallize (crystallisable).

The saline solution to be purified (1) forms a flow (2) that is joined by a flow of a concentrated salt solution (flow 23) in order to form thus a flow (3) which is sent into a heat exchanger (4) where it is cooled to a temperature of about −15° C. without generating ice, due to its high salt content.

The cooled flow (5), passes through an emulsifier (6) where it is finely mixed with a host molecule, for example 4% cyclopentane in liquid form at 0° C. (flow 7).

The emulsion coming from the emulsifier (flow 8) joins a reactor (9) in which the cyclopentane hydrate crystallizes causing a supersaturation in salt of the solution.

It is obvious that cyclopentane is given solely as an example and that the method shown in FIG. 3 can be implemented with any host molecule.

A flow (10) consisting of the cyclopentane hydrate and of the solution supersaturated in salt is sampled in the reactor (9) and is sent into a decanter (11).

The flow (10) is stabilised in the decanter (11), wherein the cyclopentane hydrate will float on the surface because its density is lower than the density of the solution, and wherein the saline solution will reach its eutectic equilibrium concentration by crystallization of the salt. The salt crystals with a density greater than that of the solution will settle at the bottom of the decanter.

Three flows are then withdrawn from the decanter (11), namely:
a flow (12) withdrawn in the upper portion of the decanter (11). This flow (12) is a cyclopentane hydrate sorbet composed of cyclopentane hydrate and of a saline solution at eutectic concentration but free of any salt crystal or precipitated salt,
a flow (13), withdrawn in the middle portion of the decanter. This flow (13) is constituted of saline solution at eutectic concentration,
a flow (14), sampled at the bottom of the decanter (11), is constituted of saline solution at eutectic concentration and of salt crystals or of settled precipitated salts but free of any cyclopentane hydrate crystal.

The flow (13) then joins a second heat exchanger (15) in order to be cooled to about −19° C. before being reintroduced upstream into the reactor (9) in the form of a flow (16).

The flow (14) is filtered in a filter (17). This filtration operation makes it possible on the one hand to obtain a flow (18) of crystallized or precipitated salts that are recovered (19), while the filtration juice or filtrate at eutectic concentration forms a flow (20) that is reinjected into the same heat exchanger (15) as the flow (13).

The flow (12) is also filtered in a filter (21) in order to recover the cyclopentane hydrate crystals of the sorbet in the form of a flow (22). The filtration juice (23), also at eutectic concentration, coming from this filtration operation, is reintroduced upstream of the method in order to be mixed with the flow (2) of solution to be purified before cooling in the exchanger (4).

The cyclopentane hydrate constituting the flow (22) is introduced into a melter (24) where is will be dissociated in order to give an emulsion of cyclopentane and of purified water (flow 25).

This emulsion (flow 25) is then introduced into a decanter (26) in order to separate the purified water from the cyclopentane.

In light of the density of 0.75 of the cyclopentane, in the bottom portion of the decanter (26) a flow (27) of purified water is withdrawn which is recovered (28) while in the upper portion of the decanter (26), a flow of cyclopentane (29) is withdrawn.

This flow of cyclopentane (29) is recycled upstream of the method in order to form with a possible supply of fresh cyclopentane (30), the flow (7), which feeds the emulsifier (6).

The invention will now be described in relation with the following example, given for illustrative and non-limiting purposes.

### Example

In this example, the treatment is carried out by the method according to the invention of a solution of NaCl at 30 g/L at a flow rate of 10 m³/day.

The method is such as described in FIG. 3, it is implemented in an installation that makes it possible to treat 10 m³ of solution/day and with cyclopentane as the host molecule.

Table I hereinbelow gives for the flows identified by numbers corresponding to the reference signs in FIG. 3, the flow rate in 10 Kg/h, the salt content in % by weight, the water content in % by weight, the cyclopentane content in % by weight, and the hydrate content in % by weight.

TABLE I

| | Flow | Salt | Water | Cyclo- | Hydrate |
|---|---|---|---|---|---|
| Flow | rate in | content | content | pentane | content |
| Number | 10 kg/h | % | % | % | % |
| 2 | 41.67 | 3.1 | 96.9 | 0 | 0 |
| 3 | 210 | 21.4 | 78.6 | 0 | 0 |
| 5 | 210 | 21.4 | 78.6 | 0 | 0 |
| 7 | 8 | 0 | 0 | 100 | 0 |
| 8 | 218 | 20 | 76 | 4 | 0 |
| 10 | 753 | 23.7 | 70.5 | 0 | 5.8 |
| 12 | 216 | 20 | 59.9 | 0 | 20 |
| 13 | 537 | 23.5 | 76.5 | 0 | 0 |
| 14 | 2.2 | 50.7 | 49.3 | 0 | 0 |
| 16 | 538 | 23.5 | 76.5 | 0 | 0 |
| 18 | 0.8 | 100 | 0 | 0 | 0 |
| 20 | 1.4 | 23.5 | 76.5 | 0 | 0 |
| 22 | 47.4 | 0.1 | 9 | 0 | 90.9 |
| 25 | 47.7 | 0.1 | 83 | 16.8 | 0 |
| 27 | 39.4 | 0.1 | 99.9 | 0 | 0 |
| 29 | 8 | 0 | 0 | 100 | 0 |

Recall that:
The flow (2) corresponds to the solution to be treated.
The flow (18) corresponds to the crystallized salts.
The flow (27) corresponds to the purified water.

1. A method for treating an aqueous solution containing dissolved materials that are able to crystallize or precipitate, by crystallization of clathrates hydrates of a host molecule which crystallize at atmospheric pressure at temperatures higher than the temperature of ice crystallization, said clathrates hydrates being less dense than said aqueous solution containing dissolved materials, wherein the following steps are carried out:
a) the aqueous solution is cooled, in first cooling means, to a temperature T1 that is higher than the temperature of ice crystallization and lower than the crystallization temperature Teq of the clathrates hydrates, and this cooled aqueous solution is introduced into a thermally insulated reactor;
b) a quantity of the host molecule is added into the reactor containing the cooled aqueous solution, such that the temperature T2 of the aqueous solution remains, following this addition and following the exothermic release due to the crystallization of the clathrates hydrates, lower than the temperature Teq, whereby the clathrates hydrates of the host molecule crystallize homogeneously in all of the volume of the aqueous solution by forming a suspension of clathrates hydrates crystallized in an aqueous solution concentrated in dissolved materials that may further contain crystallized or precipitated dissolved materials;
c) the suspension formed during step b) is sampled in the reactor, and said suspension is sent to a decanter wherein it is separated into an aqueous solution concentrated in dissolved materials and free of clathrates hydrates, into a suspension of clathrates hydrates crystallized in the form of a sorbet in an aqueous solution concentrated in dissolved materials and free of crystallized or precipitated dissolved materials, and optionally into a supersaturated suspension containing crystallized or precipitated dissolved materials and free of clathrates hydrates in an aqueous solution concentrated in dissolved materials;
d) from the decanter is withdrawn on the one hand the aqueous solution concentrated in dissolved materials and free of clathrates hydrates, and optionally on the other hand, the supersaturated suspension containing crystallized or precipitated dissolved materials and free of clathrates hydrates;
e) the aqueous solution concentrated in dissolved materials and free of clathrates hydrates withdrawn in step d), is sent back in whole into the reactor after having been cooled in second cooling means that are different from the first cooling means; or else, if in the decanter there is no supersaturated suspension then a portion of the aqueous solution concentrated in dissolved materials and free of clathrates hydrates withdrawn in step d), is sent back into the reactor after having been cooled in second cooling means, and another portion of an aqueous solution concentrated in dissolved materials and free of clathrates hydrates withdrawn in step d), is recovered and/or discharged through a purge;
f) the suspension of clathrates hydrates crystallized in the form of a sorbet in an aqueous solution concentrated in dissolved materials and free of crystallized or precipitated dissolved materials obtained in step c), is sent into a liquid/solid separation apparatus wherein solid clathrates hydrates are separated from the aqueous solution concentrated in dissolved materials and free of crystallized or precipitated dissolved materials which is recycled in order to form at least a portion of the aqueous solution cooled in step a);
g) the solid clathrates hydrates separated in step f) are sent into a reactor for dissociating clathrates hydrates in which the clathrates hydrates are dissociated into purified water and into host molecules;
h) the purified water and the host molecules obtained in step g) are separated, the purified water is recovered, and the host molecules are recycled in step b).

2. A method according to claim 1, which is carried out continuously.

3. A method according to claim 1, wherein the dissolved materials that are able to crystallize or precipitate are chosen from mineral salts selected from the group consisting of NaCl, organic salts, and water soluble compounds that have a crystallization eutectic in aqueous solution, and optionally having a density that is greater than that of the treated aqueous solution containing dissolved materials.

4. A method according to claim 1, wherein the aqueous solution containing dissolved materials is chosen from seawater; brackish waters; public landfills leachates; waters from oil production; waters for extracting shale gas by the hydraulic fracturing technique; liquids from the agri-food industry; liquids from the pharmaceutical industry; liquids from the chemical industry; mining effluents; effluents from the metallurgy industry; effluents from the nuclear industry; reverse osmosis concentrates; scaling solutions; effluents from the paper industry; and saline aquifers.

5. A method according to claim 1, wherein the treated aqueous solution has a concentration in dissolved materials from 5 g/L to the limit of saturation of these dissolved materials in water.

6. A method according to claim 1, wherein the host molecule is non-miscible in water.

7. A method according to claim 1, wherein the host molecule is chosen from the molecules that form a clathrate hydrate that has a density lower than 1.3, preferably lower than 1.2.

8. A method according to claim 1, wherein the host molecule is cyclopentane or cyclohexane.

9. A method according to claim 1, wherein during step b), the host molecule is introduced into the reactor in the form of an emulsion or solution prepared by mixing the aqueous solution cooled to the temperature T1 and the host molecules separated in step h).

10. A method according to claim 1, wherein, during step c), the suspension of clathrates hydrates crystallized is separated in the form of a sorbet in an aqueous solution concentrated in dissolved materials and free of crystallized or precipitated dissolved materials is separated, optionally continuously, on the surface of the concentrated aqueous solution.

11. A method according to claim 1, wherein, during step h) the purified water and the host molecules are separated by decantation or degassing.

12. A method according to claim 1, wherein the solid clathrates hydrates separated in step f) are washed prior to step g).

13. A method according to claim 1, wherein the temperature of the aqueous solution in the reactor and/or the concentration in host molecules in the reactor and/or the decanter and/or the quantity of aqueous solution concentrated in dissolved materials and free of clathrates hydrates withdrawn in step d), and sent back into the reactor during step e) are adjusted in order to obtain in the decanter during step c), in addition to a suspension of clathrates hydrates crystallized in the form of a sorbet, either only an aqueous solution concentrated in dissolved materials having a determined concentration, or an aqueous solution concentrated in dissolved materials having a determined concentration and a supersaturated suspension containing crystallized or precipitated dissolved materials in an aqueous solution concentrated in dissolved materials.

14. A method according to claim 13, wherein the temperature of the aqueous solution in the reactor, and/or the concentration in host molecules in the reactor and/or the decanter, and/or the quantity of aqueous solution concentrated in dissolved materials and free of clathrates hydrates withdrawn in step d), and sent back into the reactor during step e) are adjusted in such a way that eutectic conditions are present in the reactor and/or in the decanter, and that is then obtained in the decanter during step c), in addition to a suspension of clathrates hydrates crystallized in the form of a sorbet, an aqueous solution concentrated in dissolved materials at the eutectic concentration and a supersaturated suspension containing crystallized or precipitated dissolved materials in an aqueous solution concentrated in dissolved materials at the eutectic concentration.

15. A method according to claim 1, wherein the supersaturated suspension containing crystallized or precipitated dissolved materials in an aqueous solution is withdrawn in step d), and is treated in a step of solid-liquid separation whereby on the one hand crystallized or precipitated dissolved materials are obtained, which are recovered, and on the other hand an aqueous solution concentrated in dissolved materials is obtained, which is recycled in the reactor after having been cooled in the second cooling means, and/or is recovered, and/or is fully or partially discharged.

16. A method according to claim 1, wherein seeds of solid dissolved materials are further introduced into the decanter.

17. An installation for the implementation of the method according to claim 1, in order to treat an aqueous solution containing dissolved materials that are able to crystallize or precipitate by crystallization of clathrates hydrates of a host molecule which crystallize at atmospheric pressure at temperatures higher than the temperature of ice crystallization, said clathrates hydrates being less dense than said aqueous solution containing dissolved materials, said installation comprising:
a) first cooling means in order to cool the aqueous solution to a temperature T1 higher than the temperature of ice crystallization and lower than the crystallization temperature Teq of the clathrates hydrates;
b) a thermally insulated reactor;
c) means for conveying the aqueous solution cooled to the temperature T1 from the first cooling means to the thermally insulated reactor;
d) means for adding a host molecule in the reactor, whereby the clathrates hydrates of the host molecule crystallize homogeneously in all of the volume of the aqueous solution by forming a suspension of clathrates hydrates crystallized in an aqueous solution concentrated in dissolved materials that may further optionally contain crystallized or precipitated dissolved materials;
e) a decanter;
f) means for sampling in the reactor a suspension of crystallized clathrates hydrates in an aqueous solution concentrated in dissolved materials that may further contain crystallized or precipitated dissolved materials and means to send said suspension in the decanter wherein said suspension is separated into an aqueous solution concentrated in dissolved materials and free of clathrates hydrates, into a suspension of clathrates hydrates crystallized in the form of a sorbet in an aqueous solution concentrated in dissolved materials and free of crystallized or precipitated dissolved materials, and optionally into a supersaturated suspension containing crystallized or precipitated dissolved materials and free of clathrates hydrates in an aqueous solution concentrated in dissolved materials;
g) means for withdrawing from the decanter the aqueous solution concentrated in dissolved materials and free of clathrates hydrates, and optionally the supersaturated suspension containing crystallized or precipitated dissolved materials and free of clathrates hydrates;
h) means for sending back in whole or in part into the reactor the aqueous solution concentrated in dissolved materials and free of clathrates hydrates withdrawn in the decanter;
i) second cooling means different from the first cooling means for cooling before the reactor the aqueous solution concentrated in dissolved materials and free of clathrates hydrates withdrawn in the decanter provided in the means for sending back in whole or in part into the reactor the aqueous solution concentrated in dissolved materials and free of clathrates hydrates withdrawn in the decanter;
j) optionally, purging means provided in the decanter for recovering and/or discharging another portion of the an aqueous solution concentrated in dissolved materials and free of clathrates hydrates withdrawn in the decanter;
k) first liquid/solid separation means;
l) means for sending the suspension of clathrates hydrates crystallized in the form of a sorbet in an aqueous solution concentrated in dissolved materials and free of crystallized or precipitated dissolved materials separated in the decanter in the first liquid/solid separation means where solid clathrates hydrates are separated from the concentrated aqueous solution of dissolved materials and free of crystallized or precipitated dissolved materials forming a filtrate;
m) means for recycling said filtrate in said first cooling means;
n) a reactor for dissociating solid clathrates hydrates separated in said first liquid/solid separation means, in which the solid clathrates hydrates are dissociated into purified water and into host molecules;
o) means for separating the purified water and the host molecules obtained in the dissociation reactor, means for recovering the purified water, and means for sending the host molecules back into the reactor.

18. The installation according to claim 17, which comprises means to prepare an emulsion or solution by mixing the aqueous solution cooled to the temperature T1 in the first cooling means and the host molecules, and means for introducing said emulsion or solution into the reactor.

19. The installation according to claim 17, which further comprises means, for washing the solid clathrates hydrates separated in the first liquid/solid separation means.

20. The installation according to claim 17, which further comprises second solid/liquid separation means for treating the supersaturated suspension containing crystallized or precipitated dissolved materials in an aqueous solution withdrawn in the decanter and obtaining on the one hand crystallized or precipitated dissolved materials, and on the other hand an aqueous solution concentrated in dissolved materials.

21. The installation according to claim 20, which further comprises means for recycling in the reactor the aqueous solution concentrated in dissolved materials obtained in the second solid/liquid separation means.

22. The installation according to claim 21, which further comprises third cooling means, optionally confounded with the second cooling means for cooling before the reactor the aqueous solution concentrated in dissolved materials.

23. The installation according to claim 17, which further comprises means for introducing seeds of solid dissolved materials into the decanter.
